(19) United States
(12) Patent Application Publication
(10) Pub. No.: US 2013/0062228 A1
(43) Pub. Date: Mar. 14, 2013

(54) Method for prevention of pollution of the glass of the front window of a housing for an outdoor surveillance camera and a housing for implementation of this method

(71) Applicant: Nikolay Yurievich Danilov, Moscow (RU)

(72) Inventor: Nikolay Yurievich Danilov, Moscow (RU)

(73) Assignee: Zakrytoe Aktsionernoe Obshchestvo "STREAM Labs", Moscow (RU)

(21) Appl. No.: 13/199,790

(22) Filed: Sep. 9, 2011

(51) Int. Cl. B65D 67/00; B08B 5/00

(52) U.S. Cl. 206/216; 134/10

(57) ABSTRACT

This invention relates to the methods for preventing pollution of the glass of the front window of a housing for an outdoor surveillance video camera 2 and the housings in which they are implemented. On the external side of this glass 5, a pipe 3 is installed whose first butt end 8 is open to the environment and the second butt end closes the said glass. Using a blowing engine 10 installed in the housing, a pressure is being created in the pipe that exceeds the pressure outside the pipe; using a heater 11, an air flow is being heated in a closed body 1 of the housing and an air supplied to the blowing engine inlet is being cleaned using the filter 13. The microprocessor unit 12 controls the heater, the blowing engine, and the video camera. Technical result: prevention of dust, fogging, water drops, snow from accumulating and frost from depositing on the glass of the front window of the housing for the outdoor surveillance video camera.

### FIELD OF THE INVENTION

The present invention relates to outdoor surveillance and, more specifically, to methods for preventing pollution and removing dirt from the glass of the front window of a housing for an outdoor surveillance video camera and the housings wherein the said methods are implemented.

The housing for an outdoor surveillance video camera is also referred to as the case, shell, or container for the video camera. The housing contains the video camera and other required equipment. Pollution of the glass of the front window of the housing means deposit of dust, fogging, condensation of water drops, snow and frost on the window.

The invention may be used in security systems for outdoor video surveillance under different weather conditions and in unfavorable environment.

### BACKGROUND OF THE INVENTION

Known are a method for protection against pollution of the glass of the front window of the housing for an outdoor surveillance video camera that consists in installation, above the said front window, of a cover that protects against atmospheric effects and a housing (container) of an outdoor surveillance video camera in which this method is embodied (see Russian patent RU 2.280.959 of 2002, Int. Class⁸ HO4N 5/225, ‘CONTAINER FOR TELEVISION CAMERA’). FIG. 1 in that patent shows that above the front window 11 of the housing (container) 1 a cover 2 is installed that protects the window 11 against atmospheric pollution. However, this method does not ensure full protection of the front window of the video camera housing against pollution since the window is not protected against deposit of pollution along the directions not shielded by the said protective cover; for example, the direction, which is perpendicular to the window plane and passes through its center. Also, this method does not allow pollution to be removed from the window glass.

Known are a method for defogging, de-snowing and deicing the protective glass of the outdoor video camera lens based on automatic control of the temperature within the case that contains this glass and a device in which this method is embodied (see U.S. Pat. No. 7,440,025 of 2005, U.S. Class 348/373, ‘Defogging device for a surveillance camera’). This device contains an ambient temperature sensor, a heating element, an automatic control system maintaining a preset temperature and a detergent. In the said device, the protective glass may be considered to be the glass of the front window of the housing of an outdoor surveillance video camera. A disadvantage of the method and device according to U.S. Pat. No. 7,440,025 is that they are not effective against rainfalls and heavy snowing and icing nor protect they against dust pollution.

Known are methods for cleaning the glass of the front window of a housing for an outdoor surveillance video camera using a wiper, a cleaning liquid and an electric heater and the housing where these methods are embodied (see U.S. Pat. No. 6,674,476 of 1999, U.S. Class 348/375, ‘Outdoor housing for TV camera’). However, these methods are intended for removing dirt rather than for preventing pollution of the glass of the front window of the housing for an outdoor surveillance camera. The housing as per the said U.S. patent and the cleaning methods embodied in the housing are the prototypes of this invention.

### SUMMARY OF THE INVENTION

The present invention aims to develop a method for preventing pollution of the glass of the front window of a housing for an outdoor surveillance camera and a device (housing) wherein this method is embodied, which, as compared to the prototype, would ensure the technical result consisting in simultaneous fulfillment of the following goals:

prevention of deposit of dust, accumulation of water drops, snow and frost on the glass of the front window of the housing for the outdoor surveillance video camera;

provision of the cooling of the video camera located inside the housing;

maintenance of the temperature and humidity of the air within the housing at the levels optimal for video camera operations;

prevention of the exposure of the video camera lens to direct sunlight as a result of which the quality of the image produced by the video camera may be improved.

The fulfillment of the first of the specified goals is the main technical result and the fulfillment of other three goals is an additional technical result.

This technical result is attained, firstly, due to the proposed method for preventing pollution of the glass of the front window of a housing for an outdoor surveillance video camera installed in a closed body of the housing. This method consists in the following:

installing a pipe on the external side of the glass located in the front butt end of the closed body, the first (external) butt end of the pipe being open to the environment and the second (internal) butt end adjoining the front butt end of this body in such a way that the external side of the glass is closed by this butt end of the pipe;

creating a pressure in the pipe, which exceeds the outside pressure, using a blowing engine installed in the closed body of the housing and supplying compressed air through one or more slots in the front end of the said body closed by the pipe;

heating the compressed air flow supplied through the blowing engine into the pipe in the closed body of the housing a heater controlled by a microprocessor control unit;

cleaning the air supplied to the blowing engine inlet using a filter.

This allows deposit of dust, fogging, accumulation of water drops, snow and ice on the glass of the front window of the housing for an outdoor surveillance camera to be prevented by supplying heated air under pressure into the pipe.

Concurrently the following advantages are ensured:

cooling of the video camera located within the housing due to air circulation in the closed body of the housing;

maintenance of the temperature and humidity levels optimal for operations of the video camera in the closed body of the housing by heating air in that body and controlling the heating;

prevention of the exposure of the video camera lens to direct sunlight since the pipe shadows the lens from light beams thus allowing the quality of the image generated by the video camera to be improved.

Secondly, this technical result being reached is facilitated in the proposed method by performing the following operations:

switching on the heater using the microprocessor control unit if the air temperature in the closed body of the housing is below a preset value or if the air humidity in the said body is above a preset value;

switching off the heater if the air temperature in the said body attains the value set as optimal for video camera operations and the air humidity belongs to a permissible range;

switching on the video camera if the air temperature in the said body of the housing is above the minimum value permissible for its operations and the air humidity is below the maximum value permissible for operations.

This allows the air temperature and humidity in the closed body of the housing to be maintained at the levels optimal for video camera operations by controlling air heating by means of a microprocessor and sensors of air temperature and humidity.

This technical result being reached is also facilitated by the fact that the proposed method comprises calculating the internal diameter of the external butt end of the pipe using the formula:

D=(L+K+f)×M/f,

where
D is the internal diameter of the external butt end of the pipe;
L is the pipe length that depends on operation conditions defining the prevented cases of pollution of the window glass and design considerations;
K is the distance between the external side of the glass and the light-sensitive element of the video camera.
f is the focal distance of the video camera lens;
M is the length of the diagonal of the light-sensitive element of the video camera.

This ensures prevention of the glass of the front window of the housing from getting dirt while not decreasing the video camera vision angle.

The same technical result is attained due to the fact that the proposed housing of an outdoor surveillance video camera contains:

a closed body, wherein this video camera is installed and which contains the front window of the housing located in its front butt end that consists of a frame and a transparent glass attached to it;

a pipe installed on the outer side of the said glass in such a way that the first (external) butt end of this pipe is open to the environment and the second (internal) butt end of this pipe adjoins the front butt end of the closed body of the housing in such a way that the outer side of the said glass is closed by this butt end of the pipe;

wherein one or more slots are made in the frame of the said window in the front butt end of the closed body, through which air passes from this body to the said pipe;
wherein installed in the closed body of the housing are a blowing engine creating pressure in the pipe exceeding outer pressure, a heater that heats the compressed air flow supplied from the blowing engine to the pipe through the said slots and a microprocessor control unit connected with the heater, the blowing engine, and the video camera and, at the inlet to the blowing engine, a filter installed to clean the air sucked to the blowing engine from the environment.

For design considerations, within the proposed housing, the air cleaning filter is located from the side of the back butt end of the closed body of the housing.

This technical result being reached is also facilitated by the fact that in the proposed housing the internal diameter of the external butt end of the pipe is selected according to the formula:

D=(L+K+f)×M/f,

where
D is the internal diameter of the external butt end of the pipe;
L is the pipe length that depends on the operation conditions defining the prevented cases of pollution of the transparent glass of the front window and design considerations;
K is the distance between the external side of the glass and the light-sensitive element of the video camera.
f is the focal distance of the video camera lens;
M is the length of the diagonal of the light-sensitive element of the video camera.

This ensures prevention of the glass of the front window of the housing from getting dirt while not decreasing the video camera vision angle.

The technical result being reached is also facilitated by the fact that, in the proposed housing, the closed body consists of two parts, a cover and a base, on which the aforementioned video camera, the blowing engine, the heater of compressed air, the microprocessor control unit and the filter are installed; and wherein the front butt end of this body, which contains the front window of the housing with the frame and the transparent glass of the this window attached to the frame, and the back butt end of the body are parts of the said base.

This ensures simplicity of the design and user-friendly housing operations.

The technical result being reached is facilitated by the fact that, in the proposed housing, the window frame in the front butt end of closed body of the housing is designed as three rings with flat butt-end surfaces whose butt ends are interconnected and the rings are located one after another along the longitudinal axis of the said pipe passing through their centers of which the first (internal) ring is an internal part of the said frame; inside the second ring located between the first and the third rings the transparent glass of the front window of the housing is fixed; on the third (external) ring, the said pipe is fixed and, in the second and third rings, grooves are made by means of which slots are formed through which air is supplied to this pipe from the closed body of the housing.

This ensures convenient and reliable frame design that allows air to pass from the closed body of the housing to the pipe.

The technical result being attained is facilitated by the fact that, in the proposed housing, the microprocessor control unit contains a microprocessor and a power supply unit and a sensor of air temperature inside the closed body of the housing and a sensor of air humidity inside the said body, which are connected to the microprocessor.

This ensures required functionalities of the control unit.

### BRIEF DESCRIPTION OF THE DRAWINGS

FIG. 1 shows the general view of the proposed housing for an outdoor surveillance video camera.

FIG. 2 shows the structure of the proposed housing (top view with the housing cover removed).

FIG. 3 shows an example of the ring frame of the housing front window with slots on the ends of the frame ring butt end (top view).

FIG. 4 shows an example of the ring frame of the housing front window with slots in the center of the frame ring butt end in the plane wherein the window is located (top view).

FIG. 5 shows the closed body of the proposed housing with the raised cover and disassembled front part of the housing, i.e. the pipe and the ring frame of the front window of the housing.

FIG. 6 shows the structure of the microprocessor control unit of the proposed housing;

FIG. 7 shows a geometrical scheme used for calculating the internal diameter of the external butt end of the pipe of the proposed housing.

FIG. 8 shows the flow chart of the algorithm used for switching on video camera in the microprocessor control unit of the proposed housing;

FIG. 9 shows the flow chart of the algorithm used for switching on/off the heater in the microprocessor control unit of the proposed housing.

### DETAILED DESCRIPTION

Description of the Proposed Housing

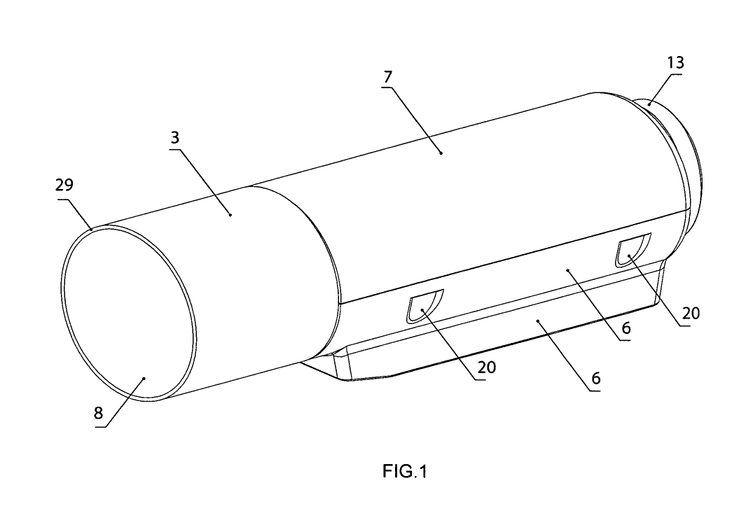

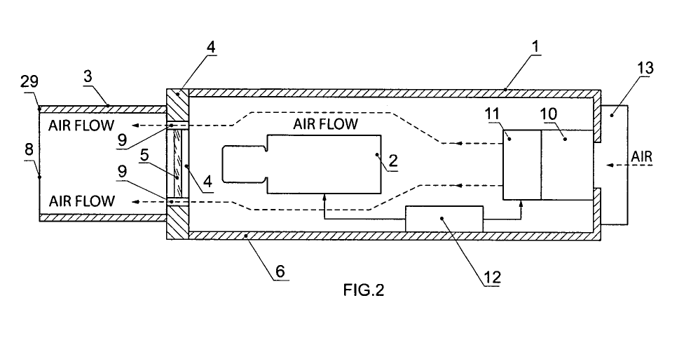

The proposed housing consists of a closed body 1, which is intended for installation in it of an outdoor surveillance video camera 2, and a pipe 3 installed on the front butt end of the body 1 (FIGS. 1 and 2). On the front butt end of the closed body 1, there is a front window of the housing consisting of a frame 4 and the transparent glass 5 fixed to the frame 4 (FIG. 2). The closed body 1 consists of the base 6 and the cover 7; the front butt end of the body 1, which contains the frame 4 with the glass 5, and the back end of the body 1 being parts of the base 6 (FIGS. 1, 2, and 5).

The first (external) end 8 of the pipe 3 is open to the environment and the second (internal) butt end of the pipe 3 is fixed on the front butt end of the closed body 1 in such a way that the external side of the transparent glass 5 is closed by this butt end of the pipe 3. In the frame 4, one or more slots 9 are made that are intended for passing of air from the closed body 1 to the pipe 3.

The internal surfaces of the base 6 and of the cover 7 may be coated with a thermal insulation material.

Inside the closed body 1, a small-size blowing engine 10 is installed for creating a pressure in the pipe 3 that exceeds the pressure outside the pipe, a heater 11 for heating the flow of the compressed air supplied from the blowing engine 10 to the pipe 3 through the slots 9, a the microprocessor control unit 12 connected with the heater 11 and the video camera 2 and, at the inlet of the blowing engine 10, a filter 13 is installed for cleaning the air supplied to the blowing engine 10 from the environment (FIG. 2).

Depending on operation conditions, different types of the small-size blowing engine 10 may be used; for example, a ventilator or a compressor may be employed. In particular, a small-size ventilator ensuring an air flow rate of 0.5 m³/min may be used.

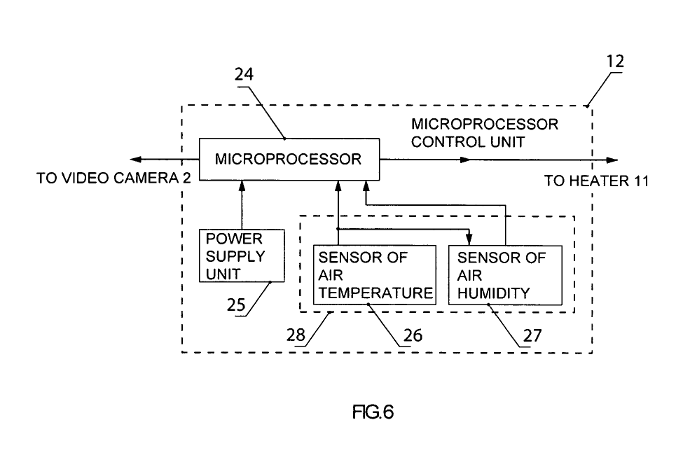

For design considerations, the filter 13 is installed on the side of the back butt end of the closed body 1. However, the filter 13 may also be located in a different way. The filter 13 may be designed as an ‘internal’ filter fully located within the closed body 1 or an ‘external’ changeable filter 13 consisting of two parts: a receiving part located inside the closed body 1 and a changeable part, which is located outside the housing, which actually performs as a changeable filter. FIGS. 2 and 5 show the ‘external’ changeable filter 13. In FIGS. 2 and 5, the parts of the ‘external’ filter 13 are not shown. If the ‘internal’ filter 13 is used, the filter 13 can only be changed after the cover 5 is lifted. If the ‘external’ changeable filter 13 is used, it can be changed without lifting the cover: it is only the changeable filter that has to be changed.

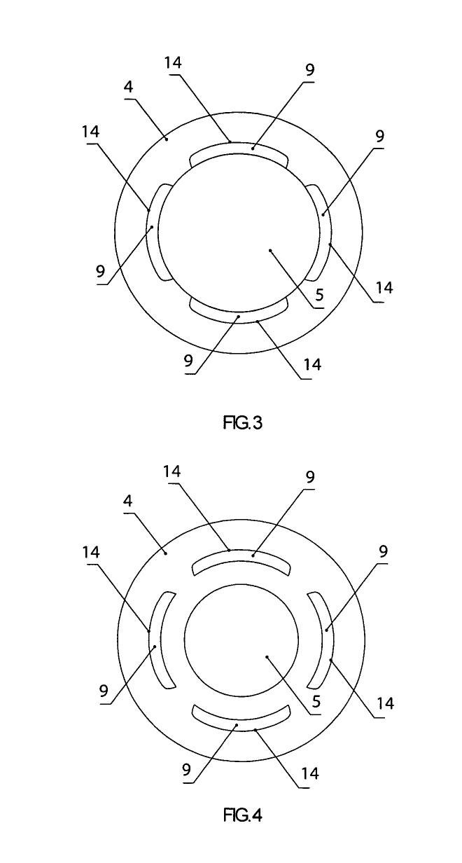

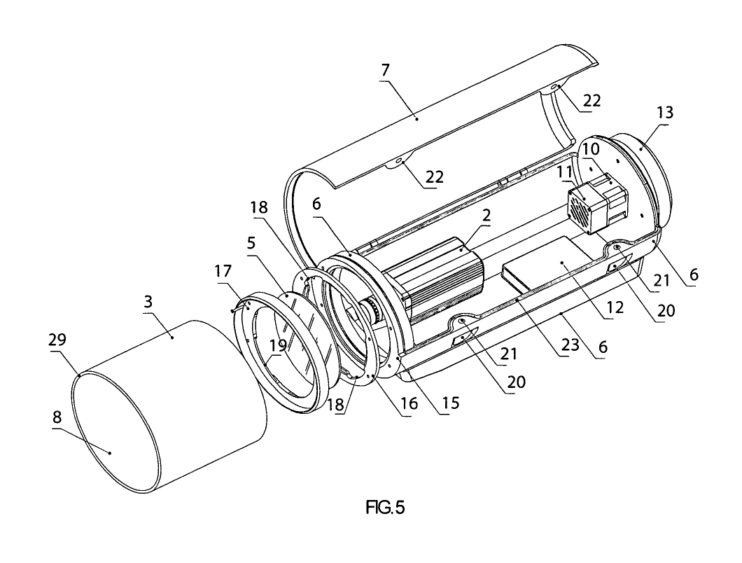

The frame 4 may be designed as a ring with through grooves 14 made on its butt ends (FIGS. 3 and 4). The grooves 14 may be located on the internal end of the butt surface of the ring 4; in this case, the slots 9 are formed between the groove walls and the transparent glass 5 (FIGS. 3 and 5). The grooves 14 may also be located not on the ends of the butt surface of the frame 4 (FIG. 4); in this case, the slots 9 are formed by the walls of the grooves 14.

The frame 4 may be designed as three rings 15, 16, 17 with flat butt end surfaces (FIG. 5) whose butt ends are interconnected. The rings 15, 16, 17 are aligned one after another along the longitudinal axis of the pipe 3 that passes through their centers. The pipe 3 is installed on the front butt end of the closed body 1 of the housing. The first (internal) ring 15 is the internal part of the frame 4. Inside the second ring 16, which is located between the first ring 15 and the third ring 17, the transparent glass 5 of the front window of the housing is fixed. On the third (external) ring 17, the pipe 3 is fixed. In the second ring 16, grooves 18 are made and, in the third ring 17, grooves 19 are made. Each groove 18 may correspond to one groove 19. The pairs of the mutually corresponding grooves 18, 19 in the frame 4 assembled of the rings 15, 16, 17 form the slots 9 for supplying air from the closed body 1 of the housing to the pipe 3.

When the rings 15, 16, 17 are assembled into the frame 4, the external butt end surface of the first (internal) ring 15 adjoins the internal butt end surface of the second ring 16 and the external butt end surface of the ring 16 adjoins the internal butt end surface of the third (external) ring 17. At the same time the second ring 16 is fixed by its internal butt end to the first ring 15 and, by the external butt end, it is fixed to the internal butt end of the third ring 17.

If the internal diameter of the first ring 15 is sufficiently large (exceeds the internal diameter of the rings 16 and 17), the first ring 15 does not have grooves similar to the grooves 18 and 19. If required, grooves may be made in the ring 15 as well (not shown on the drawing) that are similar to the grooves 18, 19 in the ring 16 and the ring 17, respectively. In the set of the rings 15, 16, 17 assembled in the frame 4, each pair of grooves 18, 19 forms together a space corresponding to one of the grooves 14 shown in FIG. 3 and, thus, forms a slot 9 for air supply from the closed body 1 to the pipe 3.

When the cover 7 is closed, it may be fixed to the base 6 using, for example, the design elements of the base 6 and the cover 7 shown in the FIGS. 5 and 1. In the base 6, holes 20, 21 are made (FIGS. 5 and 1) through which the cover 7 is fixed to the base 6 using bolts. Also, on the cover 7, juts 22 are made with holes for the bolts. If the cover 7 is closed, the aforementioned bolts pass through the holes 20, 21 and the ends of that bolts are located in the holes in the juts 22. Along the entire upper contour of the base 6, the groove 23 is made, which is filled with a sealant.

The microprocessor unit 12 comprises a microprocessor 24 and a power supply unit 25, a sensor 26 of air temperature inside the closed body 1, and a sensor 27 of air humidity inside the closed body 1 (FIG. 6), which are connected to the microprocessor 24. The sensors 26, 27 may be installed on the same board 28. The sensor 27 may be designed as a relative humidity sensor owing to which the output of the temperature sensor 26 may be connected to the sensor 27 on the board 28. The relative humidity φ at the output of the sensor 27 corresponds to the formula:

φ=(ψ×100%)/ψₘₐₓ,

where
ψ is the current absolute humidity;
ψₘₐₓ is the maximum absolute humidity at the given temperature.

The microprocessor control unit 12 can operate in a broad temperature range; for example, in the (−55° C., +125° C.) range.

The microprocessor control unit 12 implements an algorithm that controls switching on the video camera 2 and an algorithm that controls switching on/off the heater 11. These algorithms, which consist in processing the temperature values t received from the temperature sensor 26 and the humidity values φ received from the humidity sensor 27, are described in the next section.

The tools of the manual control of the devices installed in the closed body 1 (the video camera 2, the air blowing engine 10, the heater 11, and the microprocessor control unit 12) are not shown on the drawings.

The video camera 5, the heater 11, and the blowing engine 10 may either have own power supply units or be connected to the power supply unit 25. The interconnections of the power buses of these units are not shown on the drawings.

The pipe 3 may be designed as a cylinder or a truncated cone extending in the direction towards its external butt end. The thickness of the walls 29 of the pipe 3 is selected on the basis of design considerations.

In the proposed housing, the internal diameter of the external butt end of the pipe 3 is selected according to the formula:

D=(L+K+f)×M/f, (1)

where
D is the internal diameter of the external butt end of the pipe 3;
L is the length of the pipe 3 depending on the operation conditions, which define the prevented cases of pollution of the transparent glass of the front window, and design considerations;
K is the distance between the external side of the glass 5 and the light-sensitive element of the video camera 2 that is set based on design considerations;
f is the focal distance of the lens of the video camera 2;
M is the length of the diagonal of the light-sensitive element of the video camera 2.
For example, if f=25 mm, M=6 mm, K=70 mm, and L=300 mm,
the selected diameter D=95 mm.

The diameter D of the pipe 3 selected according to formula (1) ensures that the pipe 3 does not narrow the vision area (visibility area) of the video camera 2 in comparison to the prototype.

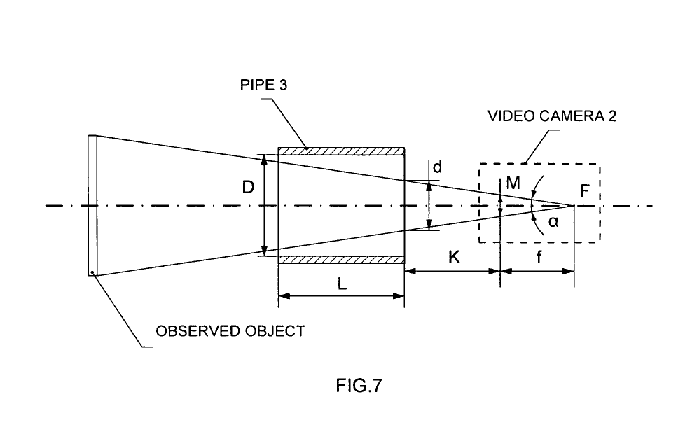

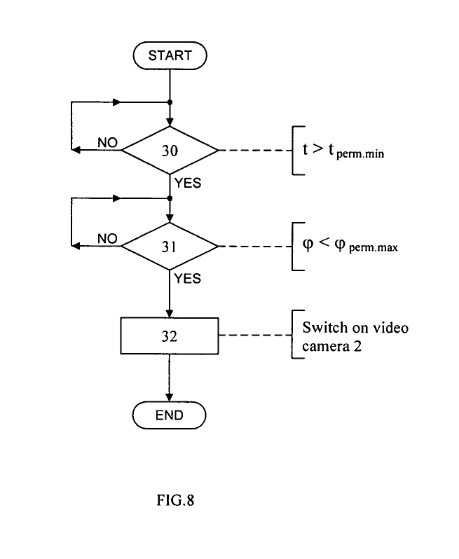

The derivation of formula (1) is illustrated by a geometrical scheme shown in FIG. 7, wherein the observed object, the pipe 3, the video camera 2, and the geometrical dimensions of the pipe 3 and the optical geometrical parameters of the video camera 2 required for deriving formula (1) are shown. In this geometrical scheme (FIG. 7), in addition to the notations defined above in formula (1), the following notations are used:

F is the back focus of the lens of the video camera 2;
α is the vision angle of the lens of the video camera 2.
As follows from the geometrical scheme shown in FIG. 7, the following expression holds:

tan(α/2)=(D/2)/(L+K+=(M/2)/f, (2)

wherein all the notations were defined above.
Expression (2) yields formula (1).

According to the geometrical scheme shown in FIG. 7, the minimum possible diameter d of the internal butt end of the pipe 3 is:

d=(K+f)×M/f, (3)

where all notations were defined above.
However, based on design considerations, it is convenient to assume that the pipe 3 has a cylindrical shape and the diameter of its internal butt end is equal to D.

The longer the pipe 3 (i.e., the larger its length L) and the larger the ratio of its length L and diameter D, the better the transparent glass 5 is protected against dirt. The reason is that the removed particles of frost, snow or other types of dirt need to pass a larger distance in the counter flow created by the air flow supplied under pressure to the pipe 3 from the closed body 1 and the flow of dirt entering the external butt end 8 of the pipe 3 from the environment and that the smaller the pipe diameter D, the higher the velocity of the air flow supplied to the pipe 3 from the closed body 1 for the given air flow rate of the blowing engine 10.

Description of the Operations of the Proposed Housing

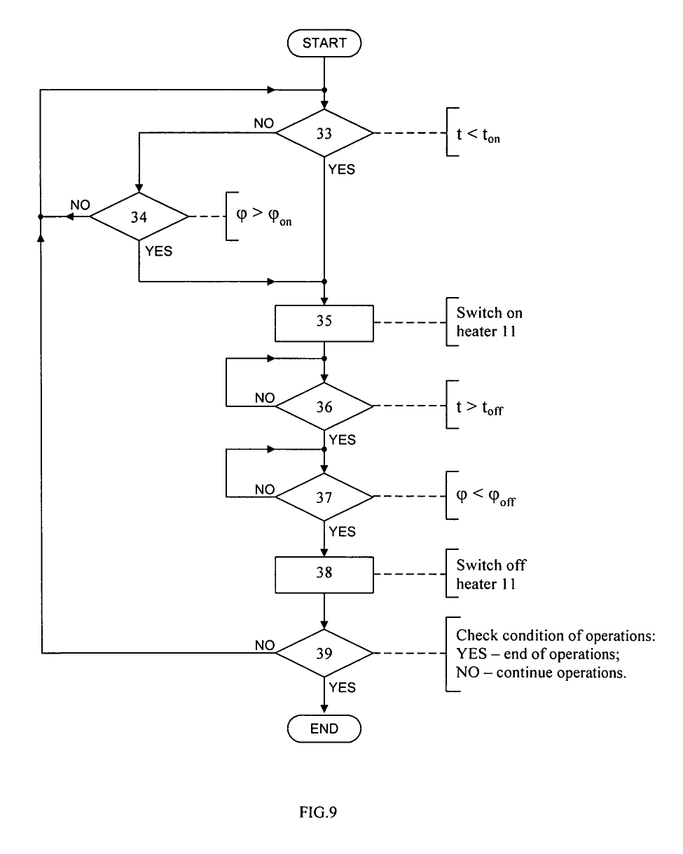

When starting the system, which comprises the proposed housing and the video camera 2, the blowing engine 10, the microprocessor control unit 12, and the video camera 2 are being switched on. The video camera 2 is being switched on automatically in accordance with the following algorithm (FIG. 8). The element 30 of the algorithm flowchart checks the current value t of the air temperature received from the sensor 26 and the element 31 checks the value φ of the humidity received from the sensor 27. The video camera 2 in the element 32 is being switched on if the air temperature t in the closed casing 1 is over the minimum temperature

t_{perm, min} permissible for operations of the video camera 2 and the current value of air humidity φ in the closed casing 1 is below the maximum humidity φ_{perm, max} permissible for operations of the video camera 2. The constants t_{perm, min} and φ_{perm, max}, which are set in the microprocessor 24, may be changed.
For example, t_{perm, min}=+10° C., φ_{perm, max}=90%.
The video camera 2 is being switched off by the operator who maintains the video surveillance system.

The heater 11 is being switched on and off automatically during video surveillance system operations in accordance with the following algorithm (FIG. 9). The elements 33, 36 of the algorithm flowchart check the current value t received from the sensor 26 and the elements 34, 37 check the value φ received from the sensor 27. The heater 11 in the element 35 is being switched on if the air temperature t in the closed body 1 is below the preset value tₒₙ (see the element 33) or if the air humidity φ in the closed body 1 is over the set value φₒₙ (see element 34). The heater 11 in the element 38 is being switched off if the air temperature t in the closed body 1 attains the preset value t_{off} adopted as the optimum for operations of the video camera 2 (see the element 36) and the air humidity φ in the closed body 1 is below the minimum permissible value φ_{off} (see the element 37), i.e., if the air humidity φ belongs to the permissible range:

0<φ<φ_{off}.

The constants tₒₙ, t_{off}, φₒₙ, and φ_{off}, which are preset in the microprocessor 24, may be changed. For example:

tₒₙ=+10° C., t_{off}=40° C.,

φₒₙ=90%, φ_{off}=70%.

After the heater 11 has been switched off, a condition for the termination of the video surveillance system operations is being checked (see the element 39), which is set in the microprocessor 24, and, if it is not fulfilled, the algorithm resumes checking the conditions for the heater 11 to be switched on (see the elements 33, 34). If the condition of the end of operations is fulfilled, the algorithm halts its operations. This condition may involve the check of the arrival of a command to halt operations sent by the operator who maintains the video surveillance system.

The ambient air passes through the filter 13 to the blowing engine 10 that creates a pressure in the pipe 3 that exceeds the pressure outside that pipe. From the blowing engine 10, the compressed air flow goes to the heater 11 wherein it is being heated. From the heater 11, the flow of heated compressed air passes through the slots 9 in the frame 4 to the pipe 3. The flow of heated compressed air passes under the pressure created by the blowing engine 10 prevents the pipe 3 from being filled with dirt, snow, frost, moisture, and dust and protects the transparent glass 5 against these substances being deposited on it.

What is claimed is:

1. A method for prevention of pollution of the glass of the front window of a housing for an outdoor surveillance video camera installed in a closed body of the housing consisting of:
installing a pipe on the external side of the glass located in the front butt end of the closed body, the first (external) butt end of the pipe being open to the environment and the second (internal) butt end adjoining the front butt end of this body in such a way that the external side of the glass is closed by this butt end of the pipe;
creating a pressure in the pipe, which exceeds the outside pressure, using a blowing engine installed in the closed body of the housing and supplying a flow of compressed air through one or more slots in the front butt end of the said body, which is closed by the pipe;
heating the compressed air flow supplied through the blowing engine into the pipe in the closed body of the housing a heater controlled by a microprocessor control unit;
cleaning the air supplied to the blowing engine inlet using a filter.

2. The method of claim 1 further comprising:
switching on the heater using the microprocessor control unit if the air temperature in the closed body of the housing is below a preset value or if the air humidity in the said body is above a preset value;
switching off the heater if the air temperature in the said body attains the value set as optimal for video camera operations and the air humidity belongs to a permissible range;
switching on the video camera if the air temperature in the said body of the housing is above the minimum value permissible for its operations and the air humidity is below the maximum value permissible for operations.

3. The method of claim 1 further comprising calculating the internal diameter of the external butt end of the pipe using the formula:
D=(K+L+f)×M/f,
where
D is the internal diameter of the external butt end of the pipe;
L is the pipe length that depends on operation conditions defining the prevented cases of pollution of the window glass and design considerations;
K is the distance between the external side of the glass and the light-sensitive element of the video camera.
f is the focal distance of the video camera lens;
M is the length of the diagonal of the light-sensitive element of the video camera.

4. A housing of an outdoor surveillance video camera that comprises:
a closed body, wherein this video camera is installed and which contains a front window of a housing located in its front butt end that consists of a frame and a transparent glass attached to it;
a pipe installed on the outer side of the said glass in such a way that the first (external) butt end of this pipe is open to the environment and the second (internal) butt end of this pipe adjoins the front butt end of the closed body of the housing in such a way that the outer side of the said glass is closed by this butt end of the pipe;
wherein one or more slots are made in the frame of the said window in the front butt end of the closed body, through which air passes from this body to the said pipe;
wherein installed in the closed body of the housing are a blowing engine creating pressure in the pipe exceeding outer pressure, a heater that heats the compressed air flow supplied from the blowing engine to the pipe through the said slots and a microprocessor control unit connected with a heater, a blowing engine, and a video camera and, at the inlet to the blowing engine, a filter installed to clean the air sucked to the blowing engine from the environment.

5. The housing of claim 4, wherein the air cleaning filter is located from the side of the back butt end of the closed body of the housing.

6. The housing of claim 4, wherein the internal diameter of the external butt end of the pipe is selected according to the formula:
D=(K+L+f)×M/f,
where
D is the internal diameter of the external butt end of the pipe;
L is the pipe length that depends on the operation conditions defining the prevented cases of pollution of the transparent glass of the front window and design considerations;
K is the distance between the external side of the glass and the light-sensitive element of the video camera.
f is the focal distance of the video camera lens;
M is the length of the diagonal of the light-sensitive element of the video camera.

7. The housing of claim 4, wherein its closed body consists of two parts, a cover and a base, on which the aforementioned video camera, the blowing engine, the heater of compressed air, the microprocessor control unit and the filter are installed; and wherein the front butt end of this body, which contains the front window of the housing with the frame and the transparent glass of the this window attached to the frame, and the back butt end of the body are parts of the said base.

8. The housing of claim 4, wherein the window frame in the front butt end of closed body of the housing is designed as three rings with flat butt-end surfaces whose butt ends are interconnected and the rings are located one after another along the longitudinal axis of the said pipe passing through their centers of which the first (internal) ring is an internal part of the said frame; inside the second ring located between the first and the third rings the transparent glass of the front window of the housing is fixed; on the third (external) ring, the said pipe is fixed and, in the second and third rings, grooves are made by means of which slots are formed through which air is supplied from the closed body of the housing to this pipe.

9. The housing of claim 4, wherein the microprocessor control unit contains a microprocessor and a power supply unit and a sensor of air temperature inside the closed body of the housing and a sensor of air humidity inside the said body, which are connected to the microprocessor.
